(19) United States
(12) Patent Application Publication
(10) Pub. No.: US 2024/0196988 A1
(43) Pub. Date: Jun. 20, 2024

(54) INHALATION DEVICE, SUBSTRATE, AND CONTROL METHOD

(71) Applicant: JAPAN TOBACCO INC., Tokyo (JP)

(72) Inventors: Toru NAGAHAMA, Tokyo (JP); Junji MINATO, Tokyo (JP); Tatsunari AOYAMA, Tokyo (JP)

(73) Assignee: JAPAN TOBACCO INC., Tokyo (JP)

(21) Appl. No.: 18/591,409

(22) Filed: Feb. 29, 2024

Related U.S. Application Data
(63) Continuation of application No. PCT/JP2021/040040, filed on Oct. 29, 2021.

(51) Int. Cl. A24F 40/57; A24F 40/46; H05B 1/02

(52) U.S. Cl. CPC A24F 40/57; A24F 40/46; H05B 1/0252

(57) ABSTRACT

An inhalation device including: a heating unit that heats a substrate containing an aerosol source to produce an aerosol; and a control unit that, on the basis of a temperature setting that defines a time-series transition for a target temperature, which is the target value of the temperature of the heating unit, controls the operation of the heating unit. The control unit performs control so that among a plurality of periods included in the temperature setting, a first voltage is applied to the heating unit during a first period, and a second voltage that differs from the first voltage is applied to the heating unit during a second period that differs from the first period.

### CROSS REFERENCES TO RELATED APPLICATIONS

This application is a Continuation of PCT International Application No. PCT/JP2021/040040, filed on Oct. 29, 2021, which is hereby expressly incorporated by reference into the present application.

### TECHNICAL FIELD

The present invention relates to an inhaler device, a substrate, and a control method.

### BACKGROUND ART

Inhaler devices, such as e-cigarettes and nebulizers, that generate material to be inhaled by a user are widespread. For example, an inhaler device generates an aerosol having a flavor component imparted thereto, by using a substrate including an aerosol source for generating the aerosol, a flavor source for imparting the flavor component to the generated aerosol, and the like. A user is able to enjoy the flavor by inhaling the aerosol having the flavor component imparted thereto, which is generated by the inhaler device. An action of a user inhaling an aerosol will be hereinafter also referred to as a puff or a puff action.

Typically, an inhaler device generates an aerosol by heating a substrate. The quality of user experience is greatly affected by the temperature at which the substrate is heated, and thus techniques have been developed to achieve appropriate temperature control. For example, the following Patent Literature 1 discloses a technique of adjusting, based on the temperature of a heat generation element that heats a substrate, a voltage to be output to a heating element.

### CITATION LIST

### Patent Literature

Patent Literature 1: JP 6667690 B2

### SUMMARY OF INVENTION

### Technical Problem

Typically, in a period during which a substrate is heated, the temperature of a heat generation element irregularly changes due to an influence of a puff or the like taken by a user. Thus, in the technique described in Patent Literature 1, an output voltage may be frequently adjusted. Such irregular and frequent voltage adjustment may cause various inconveniences.

Accordingly, the present invention has been made in view of the above issue, and an object of the present invention is to provide a mechanism capable of suppressing the occurrence of inconvenience associated with voltage adjustment.

### Solution to Problem

To solve the above issue, according to an aspect of the present invention, there is provided an inhaler device including a heater configured to heat a substrate including an aerosol source to generate an aerosol; and a controller configured to control, based on a temperature setting defining a time-series transition of a target temperature, the target temperature being a target value of a temperature of the heater, an operation of the heater. The controller is configured to perform control such that a first voltage is applied to the heater in a first period among a plurality of periods included in the temperature setting and that a second voltage different from the first voltage is applied to the heater in a second period different from the first period among the plurality of periods.

The temperature setting may include a third period between the first period and the second period. The controller may be configured to perform control such that no voltage is applied to the heater in the third period.

The third period may be a period during which the temperature of the heater drops.

The first period may be a period during which the temperature of the heater rises from a temperature at start of heating to a predetermined temperature.

The second period may be a period after the temperature of the heater has dropped and be a period during which the temperature of the heater is maintained or rises.

The first voltage may be higher than the second voltage.

The controller may be configured to control, based on an environmental temperature, at least one of the first voltage or the second voltage.

The controller may be configured to set at least one of the first voltage or the second voltage to a larger value when the environmental temperature is lower than a first reference value.

The controller may be configured to set at least one of the first voltage or the second voltage to a smaller value when the environmental temperature is higher than or equal to a second reference value.

The controller may be configured to determine, based on the environmental temperature, at least one of the first voltage or the second voltage before controlling, based on the temperature setting, the operation of the heater.

The controller may be configured to control, based on the temperature of the heater in the first period, the second voltage.

The controller may be configured to control, based on information regarding a puff of the aerosol taken by a user in the first period, the second voltage.

The controller may be configured to control, based on a type of the substrate to be heated by the heater, at least one of the first voltage or the second voltage.

The inhaler device may include, as the heater, a first heater disposed on a downstream side and a second heater disposed on an upstream side. The controller may be configured to perform control such that the first voltage is applied to the first heater in the first period, that the second voltage is applied to the first heater in the second period, and that a fourth voltage is applied to the second heater in a fourth period that overlaps the first period and the second period.

The fourth voltage may be lower than the first voltage and higher than the second voltage.

To solve the above issue, according to another aspect of the present invention, there is provided a substrate that includes an aerosol source and that is to be heated by an inhaler device to generate an aerosol. The inhaler device includes a heater configured to heat the substrate including the aerosol source to generate the aerosol; and a controller configured to control, based on a temperature setting defining a time-series transition of a target temperature, the target temperature being a target value of a temperature of the heater, an operation of the heater. The controller is configured to perform control such that a first voltage is applied to the heater in a first period among a plurality of periods included in the temperature setting and that a second voltage different from the first voltage is applied to the heater in a second period different from the first period among the plurality of periods.

To solve the above issue, according to another aspect of the present invention, there is provided a control method for controlling an inhaler device including a heater configured to heat a substrate including an aerosol source to generate an aerosol. The control method includes controlling, based on a temperature setting defining a time-series transition of a target temperature, the target temperature being a target value of a temperature of the heater, an operation of the heater. The controlling of the operation of the heater includes performing control such that a first voltage is applied to the heater in a first period among a plurality of periods included in the temperature setting and that a second voltage different from the first voltage is applied to the heater in a second period different from the first period among the plurality of periods.

### Advantageous Effects of Invention

As described above, according to the present invention, there is provided a mechanism capable of suppressing the occurrence of inconvenience associated with voltage adjustment.

### BRIEF DESCRIPTION OF DRAWINGS

FIG. 1 is a schematic diagram of an inhaler device according to a configuration example.

FIG. 2 is a graph showing an example of the transition of the temperature of a heater in a case where temperature control is performed based on the heating profile shown in Table 1.

FIG. 3 is a diagram for describing control of a voltage to be applied to the heater.

FIG. 4 is a flowchart illustrating an example of a flow of a process executed by the inhaler device according to an embodiment.

FIG. 5 is a schematic diagram of a configuration example of an inhaler device according to a modification.

FIG. 6 is a graph showing an example of the transition of the temperature of the heater according to the modification.

### DESCRIPTION OF EMBODIMENTS

Hereinafter, a preferred embodiment of the present invention will be described in detail with reference to the accompanying drawings. In the specification and the drawings, structural elements having substantially the same functional configuration are denoted by the same reference signs, and a duplicate description will be omitted.

### 1. Configuration Example

An inhaler device generates material to be inhaled by a user. In the example described below, the material generated by the inhaler device is an aerosol. Alternatively, the material generated by the inhaler device may be gas.

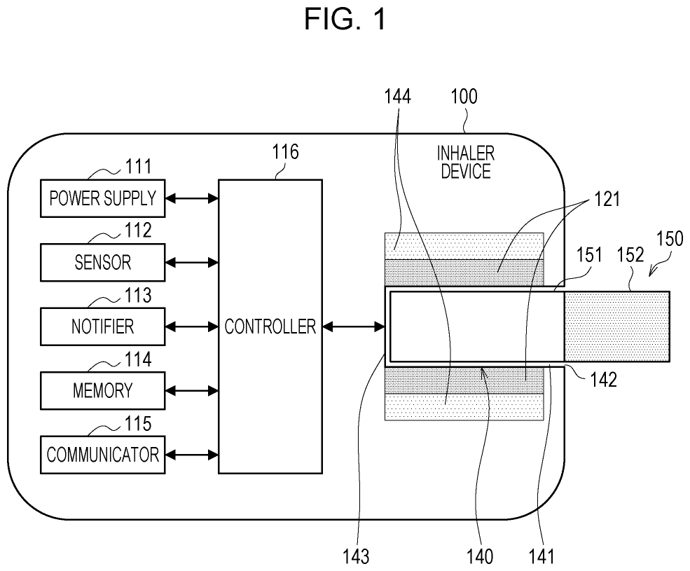

FIG. 1 is a schematic diagram of the inhaler device according to a configuration example. As illustrated in FIG. 1, an inhaler device 100 according to the present configuration example includes a power supply 111, a sensor 112, a notifier 113, a memory 114, a communicator 115, a controller 116, a heater 121, a holder 140, and a heat insulator 144.

The power supply 111 stores electric power. The power supply 111 supplies electric power to the structural elements of the inhaler device 100 under the control of the controller 116. The power supply 111 may be a rechargeable battery such as a lithium ion secondary battery.

The sensor 112 acquires various items of information regarding the inhaler device 100. In an example, the sensor 112 may be a pressure sensor such as a condenser microphone, a flow sensor, or a temperature sensor, and acquire a value generated in accordance with the user's inhalation. In another example, the sensor 112 may be an input device that receives information input by the user, such as a button or a switch.

The notifier 113 provides information to the user. The notifier 113 may be a light-emitting device that emits light, a display device that displays an image, a sound output device that outputs sound, or a vibration device that vibrates.

The memory 114 stores various items of information for operation of the inhaler device 100. The memory 114 may be a non-volatile storage medium such as flash memory.

The communicator 115 is a communication interface capable of communication in conformity with any wired or wireless communication standard. Such a communication standard may be, for example, Wi-Fi (registered trademark) or Bluetooth (registered trademark).

The controller 116 functions as an arithmetic processing unit and a control circuit, and controls the overall operations of the inhaler device 100 in accordance with various programs. The controller 116 includes an electronic circuit such as a central processing unit (CPU) or a microprocessor, for example.

The holder 140 has an internal space 141, and holds a stick substrate 150 in a manner partially accommodated in the internal space 141. The holder 140 has an opening 142 that allows the internal space 141 to communicate with outside. The holder 140 holds the stick substrate 150 that is inserted into the internal space 141 through the opening 142. For example, the holder 140 may be a tubular body having the opening 142 and a bottom 143 on its ends, and may define the pillar-shaped internal space 141. The holder 140 also has a function of defining a flow path of air supplied to the stick substrate 150. An air inlet hole, which is an inlet of air to the flow path, is disposed in the bottom 143, for example. On the other hand, an air outlet hole, which is an outlet of air from the flow path, is the opening 142.

The stick substrate 150 includes a substrate 151 and an inhalation port 152. The substrate 151 includes an aerosol source and a flavor source. The aerosol source is a liquid such as polyhydric alcohol or water. Examples of the polyhydric alcohol include glycerine and propylene glycol. Of course, the aerosol source is not limited to a liquid and may be a solid. The flavor source is a member that imparts a flavor component to the aerosol. The flavor source may include a flavor component that is either derived from tobacco or not derived from tobacco. The stick substrate 150 held by the holder 140 includes the substrate 151 at least partially accommodated in the internal space 141 and the inhalation port 152 at least partially protruding from the opening 142. When the user inhales with the inhalation port 152 protruding from the opening 142 in his/her mouth, air flows into the internal space 141 through the air inlet hole (not illustrated), and the air and an aerosol generated from the substrate 151 reach inside the mouth of the user.

The heater 121 heats the aerosol source to atomize the aerosol source and generate the aerosol. In the example illustrated in FIG. 1, the heater 121 has a film-like shape and surrounds the outer circumference of the holder 140. Subsequently, heat produced from the heater 121 heats the substrate 151 of the stick substrate 150 from the outer circumference, generating the aerosol. The heater 121 produces heat when supplied with electric power from the power supply 111. In an example, the electric power may be supplied in response to the sensor 112 detecting a start of the user's inhalation and/or an input of predetermined information. Subsequently, the supply of the electric power may be stopped in response to the sensor 112 detecting an end of the user's inhalation and/or an input of predetermined information.

The heat insulator 144 prevents heat from transferring from the heater 121 to the other structural elements. For example, the heat insulator 144 may be a vacuum heat insulator or an aerogel heat insulator.

The configuration example of the inhaler device 100 has been described above. The inhaler device 100 is not limited to the above configuration, and may be configured in various ways as exemplified below.

In an example, the heater 121 may have a blade-like shape, and may be disposed so that the heater 121 protrudes from the bottom 143 of the holder 140 toward the internal space 141. In this case, the heater 121 having the blade-like shape is inserted into the substrate 151 of the stick substrate 150 and heats the substrate 151 of the stick substrate 150 from its inside. In another example, the heater 121 may be disposed so that the heater 121 covers the bottom 143 of the holder 140. In still another example, the heater 121 may be implemented as a combination of two or more selected from a first heater that covers the outer circumference of the holder 140, a second heater having the blade-like shape, and a third heater that covers the bottom 143 of the holder 140.

In another example, the holder 140 may include an opening/closing mechanism that at least partially opens and closes an outer shell defining the internal space 141. Examples of the opening/closing mechanism include a hinge. In addition, the holder 140 may accommodate the stick substrate 150 while sandwiching the stick substrate 150 inserted into the internal space 141 by opening and closing the outer shell. In this case, the heater 121 may be at the sandwiching position of the holder 140 and may produce heat while pressing the stick substrate 150.

In addition, means for atomizing the aerosol source is not limited to heating by the heater 121. For example, the means for atomizing the aerosol source may be induction heating.

The inhaler device 100 and the stick substrate 150 cooperate with each other to generate an aerosol to be inhaled by the user. Thus, the combination of the inhaler device 100 and the stick substrate 150 may be regarded as an aerosol generation system.

### 2. Technical Features

### (1) Heating Profile

The controller 116 controls the operation of the heater 121, based on a temperature setting. The control of the operation of the heater 121 is implemented by controlling supply of electric power from the power supply 111 to the heater 121. The temperature setting is information defining a time-series transition of a target temperature, which is a target value of the temperature of the heater 121. Hereinafter, such a temperature setting is also referred to as a heating profile.

The controller 116 controls the temperature of the heater 121 such that the transition of the temperature (hereinafter also referred to as an actual temperature) of the heater 121 becomes similar to the transition of the target temperature defined in the heating profile. The heating profile is typically designed to optimize the flavor that a user tastes when the user inhales an aerosol generated from the stick substrate 150. Thus, controlling of supply of electric power to the heater 121 based on the heating profile makes it possible to optimize the flavor that the user tastes.

The heating profile includes one or more combinations of a target temperature and information indicating a timing at which the target temperature is to be reached. The controller 116 controls the temperature of the heater 121 while switching the target temperature in accordance with the elapse of time from the start of heating based on the heating profile. Specifically, the controller 116 controls the temperature of the heater 121, based on the difference between a current actual temperature and a target temperature corresponding to the elapsed time from the start of heating based on the heating profile. The temperature control of the heater 121 can be implemented by, for example, known feedback control. The feedback control may be, for example, proportional-integral-differential controller (PID controller). The controller 116 may cause electric power from the power supply 111 to be supplied to the heater 121 in the form of pulses generated by pulse width modulation (PWM) or pulse frequency modulation (PFM). In this case, the controller 116 is capable of controlling the temperature of the heater 121 by adjusting the duty ratio or frequency of electric power pulses in the feedback control. Alternatively, the controller 116 may perform simple ON/OFF control in the feedback control. For example, the controller 116 may execute heating by the heater 121 until the actual temperature reaches the target temperature, stop heating by the heater 121 in response to the actual temperature reaching the target temperature, and execute heating by the heater 121 again in response to the actual temperature becoming lower than the target temperature.

The temperature of the heater 121 can be quantified by, for example, measuring or estimating the electric resistance value of the heater 121 (more accurately, a heating resistor constituting the heater 121). This is because the electric resistance value of the heating resistor changes according to the temperature. The electric resistance value of the heating resistor can be estimated by, for example, measuring the amount of voltage drop in the heating resistor. The amount of voltage drop in the heating resistor can be measured by a voltage sensor that measures a potential difference applied to the heating resistor. In another example, the temperature of the heater 121 can be measured by a temperature sensor, such as a thermistor, installed near the heater 121.

A period from the start to the end of the process of generating an aerosol using the stick substrate 150 will be hereinafter also referred to as a heating session. In other words, the heating session is a period during which supply of electric power to the heater 121 is controlled based on the heating profile. The start of the heating session is a timing at which heating based on the heating profile is started. The end of the heating session is a timing at which a sufficient amount of aerosol is no longer generated. The heating session includes a first preheating period and a latter puffable period. The puffable period is a period during which a sufficient amount of aerosol is estimated to be generated. The preheating period is a period from the start of heating to the start of the puffable period. The heating performed in the preheating period is also referred to as preheating.

The heating profile may include a plurality of periods having, set therein, target temperatures different from each other. Temperature control may be performed such that a target temperature set in a certain period is reached at a certain timing in the period, or temperature control may be performed such that the target temperature is reached at the end of the period. In any case, it is possible to change the temperature of the heater 121 in a manner similar to the transition of the target temperature defined in the heating profile.

An example of the heating profile is shown in Table 1 below.

TABLE 1
Example of heating profile

| | Elapsed time from start | Target |
|---|---|---|
| Period | of heating | temperature |
| Initial temperature rise period | 0 sec. to 17 sec. | 310° C. |
| | 17 sec. to 35 sec. | 310° C. |
| Intermediate temperature drop | 35 sec. to 45 sec. | 260° C. |
| period | | |
| Temperature re-rise period | 45 sec. to 180 sec. | 290° C. |
| | 180 sec. to 260 sec. | 290° C. |
| Heating termination period | Thereafter | — |

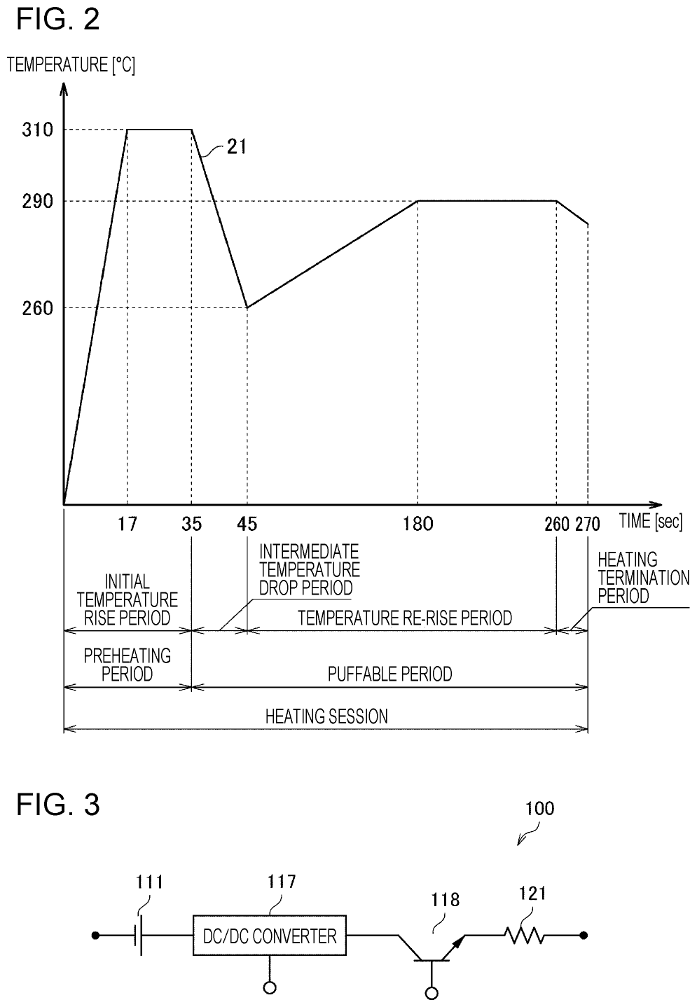

A description will be given of the transition of the temperature of the heater 121 in a case where the controller 116 performs temperature control in accordance with the heating profile shown in Table 1, with reference to FIG. 2. FIG. 2 is a graph showing an example of the transition of the temperature of the heater 121 in a case where temperature control is performed based on the heating profile shown in Table 1. The horizontal axis of this graph represents time (seconds). The vertical axis of this graph represents the temperature of the heater 121. The line 21 in this graph indicates the transition of the temperature of the heater 121. As illustrated in FIG. 2, the temperature of the heater 121 changes in a manner similar to the transition of the target temperature defined in the heating profile.

As shown in Table 1, the heating profile includes an initial temperature rise period at the beginning. The initial temperature rise period is a period during which the temperature of the heater 121 rises from an initial temperature to a predetermined temperature. The initial temperature is the temperature of the heater 121 at the start of heating. As illustrated in FIG. 2, in the initial temperature rise period, the temperature of the heater 121 reaches 310° C. after 17 seconds from the start of heating, and is maintained at 310° C. until after 35 seconds from the start of heating. Accordingly, it is estimated that the temperature of the stick substrate 150 reaches a temperature at which a sufficient amount of aerosol is generated. Because the temperature rapidly rises to 310° C. immediately after the start of heating, preheating can be finished early, and the puffable period can be started early. In FIG. 2, the initial temperature rise period and the preheating period coincide with each other, but these periods do not have to coincide with each other.

As shown in Table 1, the heating profile includes an intermediate temperature drop period that follows the initial temperature rise period. The intermediate temperature drop period is a period during which the temperature of the heater 121 drops. As illustrated in FIG. 2, in the intermediate temperature drop period, the temperature of the heater 121 drops from 310° C. to 260° C. from 35 seconds to 45 seconds after the start of heating. In this period, supply of electric power to the heater 121 may be stopped. Even in this case, a sufficient amount of aerosol is generated by the remaining heat of the heater 121 and the stick substrate 150. Here, if the heater 121 is maintained at a high temperature, the aerosol source included in the stick substrate 150 is rapidly consumed, which may cause deterioration of flavor, such as excessively strong flavor tasted by the user. In this regard, the intermediate temperature drop period provided in the middle makes it possible to avoid such deterioration of flavor and improve the quality of puff experience of the user.

As shown in Table 1, the heating profile includes a temperature re-rise period that follows the intermediate temperature drop period. The temperature re-rise period is a period after the temperature of the heater 121 has dropped, and is a period during which the temperature of the heater 121 rises. As illustrated in FIG. 2, in the temperature re-rise period, the temperature of the heater 121 rises from 260° ° C. to 290° C. from 45 seconds to 180 seconds after the start of heating, and is maintained at 290° C. until after 260 seconds from the start of heating. If the temperature of the heater 121 is continuously decreased, the temperature of the stick substrate 150 is also decreased. Thus, the amount of aerosol generated reduces, and the flavor tasted by the user may be deteriorated. In addition, as the heating profile progresses toward the end, the remaining amount of the aerosol source included in the stick substrate 150 decreases, and thus the amount of aerosol generated tends to reduce even if heating is continued at the same temperature. In this regard, re-rise of the temperature and an increase in the amount of aerosol generated in the latter half of the heating profile make it possible to compensate for a decrease in the amount of aerosol generated caused by a decrease in the remaining amount of the aerosol source. Accordingly, even in the latter half of the heating profile, it is possible to prevent deterioration of the flavor that the user tastes.

As shown in Table 1, the heating profile includes a heating termination period at the end. The heating termination period is a period that follows the temperature re-rise period, and is a period during which heating is not performed. A target temperature need not necessarily be set. As illustrated in FIG. 2, the temperature of the heater 121 decreases from 260 seconds after the start of heating. The supply of electric power to the heater 121 may be terminated after 260 seconds from the start of heating. Even in this case, a sufficient amount of aerosol is generated for a while by the remaining heat of the heater 121 and the stick substrate 150. In the example illustrated in FIG. 2, the puffable period, that is, the heating session, terminates after 270 seconds from the start of heating.

The user may be notified of the timing at which the puffable period starts and the timing at which the puffable period terminates. Furthermore, the user may be notified of a timing that is a predetermined time before the puffable period terminates (for example, the timing at which supply of electric power to the heater 121 terminates). In this case, the user is able to take a puff in the puffable period with reference to the notification.

### (2) Voltage Control Based on Heating Profile

The controller 116 controls the voltage to be applied to the heater 121. The control of the voltage to be applied to the heater 121 will be described in detail with reference to FIG. 3.

FIG. 3 is a diagram for describing the control of the voltage to be applied to the heater 121. As illustrated in FIG. 3, the inhaler device 100 includes a DC/DC converter 117 and a switching element 118 that are disposed between the power supply 111 and the heater 121.

In the example illustrated in FIG. 3, the power supply 111 is a direct current (DC) power supply. The power supply 111 supplies DC electric power.

The DC/DC converter 117 is a device that adjusts the voltage of the DC electric power applied thereto and outputs the adjusted voltage. The DC/DC converter 117 raises or lowers the applied voltage and outputs the raised or lowered voltage under control by the controller 116.

The switching element 118 is a device that connects a circuit in an ON state and disconnects the circuit in an OFF state. The switching element 118 switches between supply and stop of electric power to the heater 121 under control by the controller 116. For example, the controller 116 causes the switching element 118 to be in an ON state for a period corresponding to an ON pulse width in PWM control, and causes the switching element 118 to be in an OFF state for a period corresponding to an OFF pulse width.

With the above-described configuration, an electric power pulse having a voltage adjusted by the DC/DC converter 117 and having a pulse width adjusted by the switching element 118 is applied to the heater 121.

When a voltage is changed while the voltage is applied to the heater 121 (including an OFF period in PWM control), noise is superimposed on the gain of PID controller. The gain of PID controller includes a gain Kp of a proportional term, a gain Ki of an integral term, and a gain Kd of a differential term. When noise is superimposed on the gain of PID controller, it is difficult to appropriately control the temperature of the heater 121, and an inappropriate aerosol may be delivered to a user.

Accordingly, the controller 116 performs control such that a first voltage is applied to the heater 121 in a first period among a plurality of periods included in a heating profile and that a second voltage different from the first voltage is applied to the heater 121 in a second period different from the first period among the plurality of periods. That is, the controller 116 adjusts, at a specific timing in the heating profile, the voltage to be applied to the heater 121. Thus, the timing at which noise is superimposed on the gain of PID controller is determined by the relationship with the heating profile. Thus, it is possible to appropriately control the temperature of the heater 121 compared to a case where voltage adjustment is irregularly and frequently performed, that is, a case where noise is irregularly and frequently superimposed on the gain of PID controller.

The first period may be the initial temperature rise period. The second period may be the temperature re-rise period. With this configuration, in the two periods in which time-series transitions of different target temperatures are defined, it is possible to apply an optimum voltage to the heater 121 in each period.

The first voltage is higher than the second voltage. In the initial temperature rise period, a rapid temperature rise is required to shorten the preheating period. In this regard, it is possible to easily realize such a rapid temperature rise by applying the first voltage, which is relatively high, to the heater 121 in the initial temperature rise period. On the other hand, in the temperature re-rise period, the temperature may be slowly raised to prevent depletion of the aerosol source. In this regard, it is possible to reduce power consumption while realizing a slow temperature rise by applying the second voltage, which is relatively low, to the heater 121 in the temperature re-rise period.

The controller 116 performs control such that no voltage is applied to the heater 121 in a third period between the first period and the second period. That is, the controller 116 stops supply of electric power to the heater 121 in the third period. With this configuration, the voltage applied to the heater 121 is changed before and after the period during which no voltage is applied to the heater 121, and thus it is possible to prevent noise from being superimposed on the gain of PID controller. Thus, it is possible to appropriately control the temperature of the heater 121 in the first period and the second period and deliver an appropriate aerosol to the user.

The third period may be the intermediate temperature drop period. That is, the controller 116 may apply the first voltage to the heater 121 in the initial temperature rise period, apply a zero voltage to the heater 121 in the intermediate temperature drop period, and apply the second voltage to the heater 121 in the temperature re-rise period. With this configuration, it is possible to appropriately control the temperature of the heater 121 and deliver an appropriate aerosol to the user throughout the heating session.

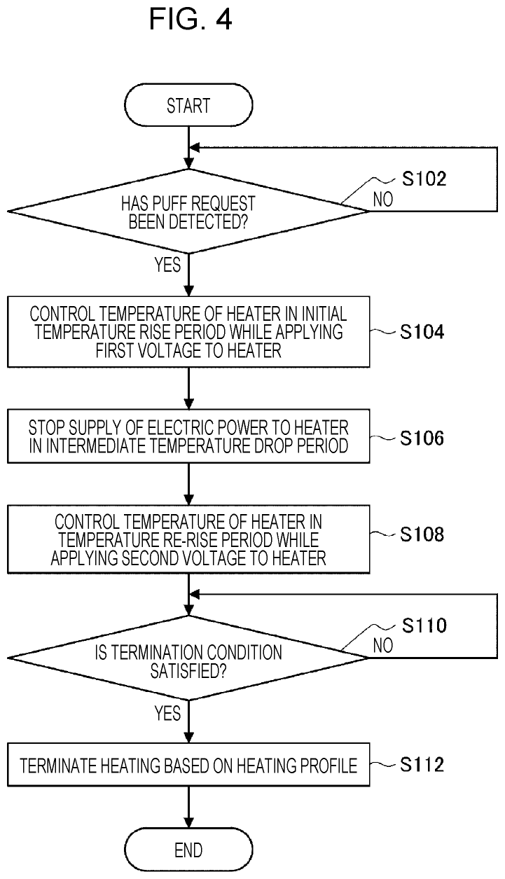

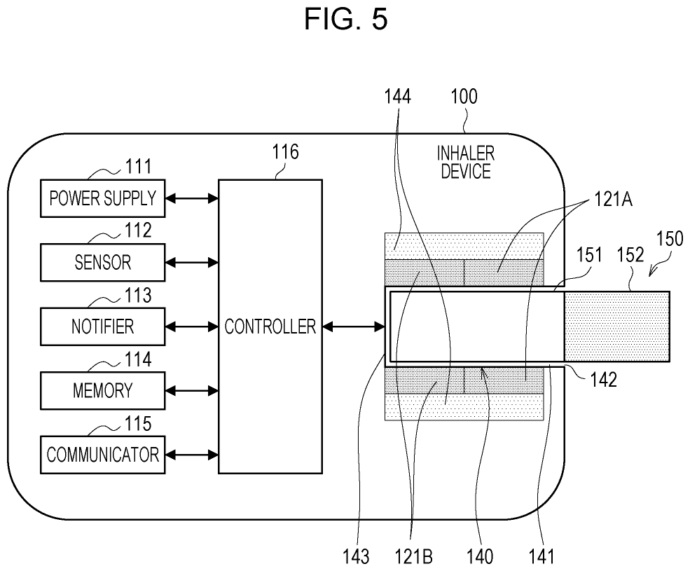

FIG. 4 is a flowchart illustrating an example of a flow of a process executed by the inhaler device 100 according to the present embodiment.

As illustrated in FIG. 4, first, the controller 116 determines whether a puff request has been detected (step S102). The puff request is a user operation requesting generation of an aerosol. An example of the puff request is an operation on the inhaler device 100, such as an operation on a switch or the like provided in the inhaler device 100. Another example of the puff request is insertion of the stick substrate 150 into the inhaler device 100. The insertion of the stick substrate 150 into the inhaler device 100 may be detected by a capacitive proximity sensor that detects the capacitance in a space near the opening 142, a pressure sensor that detects the pressure in the internal space 141, or the like.

If it is determined that a puff request has not been detected (NO in step S102), the controller 116 waits until a puff request has been detected.

On the other hand, if it is determined that a puff request has been detected (YES in step S102), the controller 116 controls the temperature of the heater 121 in the initial temperature rise period while applying the first voltage to the heater 121 (step S104).

Subsequently, the controller 116 stops supply of electric power to the heater 121 in the intermediate temperature drop period (step S106).

Subsequently, the controller 116 controls the temperature of the heater 121 in the temperature re-rise period while applying the second voltage to the heater 121 (step S108).

Subsequently, the controller 116 determines whether a termination condition is satisfied (step S110). An example of the termination condition is that the elapsed time from the start of heating has reached a predetermined time. Another example of the termination condition is that the number of puffs from the start of heating has reached a predetermined number.

If it is determined that the termination condition is not satisfied (NO in step S110), the controller 116 waits until the termination condition is satisfied.

If it is determined that the termination condition is satisfied (YES in step S110), the controller 116 terminates the heating based on the heating profile (step S112). Thereafter, the process ends.

### 3. Modifications

### (1) First Modification

The controller 116 may control, based on an environmental temperature, the first voltage and the second voltage. The environmental temperature is the temperature of an environment that may affect the temperature of the heater 121. Examples of the environmental temperature include the temperature of the surroundings of the inhaler device 100 (i.e., ambient temperature), the temperature inside the housing of the inhaler device 100, and the temperature of the power supply 111. The inhaler device 100 may include a temperature sensor for detecting an environmental temperature, or may receive an environmental temperature from a smartphone, a server, or the like. Considering that an environmental temperature may affect the temperature of the heater 121, such a configuration makes it possible to more appropriately control the temperature of the heater 121.

Table 2 provided below shows an example of the relationship between the environmental temperature and the first and second voltages.

TABLE 2
Example of relationship between environmental
temperature and voltages

| Environmental temperature | First voltage | Second voltage |
|---|---|---|
| 30° C. or higher | V_{1A} (V_{1A} < V₁) | V_{2A} (V_{2A} < V₂) |
| 10° C. or higher and lower than | V₁ | V₂ |
| 30° C. | | |
| Lower than 10° C. | V_{1B} (V₁ < V_{1B}) | V_{2B} (V₂ < V_{2B}) |

When the environmental temperature is higher than or equal to a first reference value and lower than a second reference value, the controller 116 sets default values as the first voltage and the second voltage. According to the example shown in Table 2, when the environmental temperature is higher than or equal to 10° C. and lower than 30° C., the controller 116 sets the first voltage to a default of V₁ and sets a the second voltage to a default of V₂.

When the environmental temperature is lower than the first reference value, the controller 116 sets the first voltage and the second voltage to larger values. According to the example shown in Table 2, when the environmental temperature is lower than 10° C., the controller 116 sets the first voltage to VIB higher than the default of V₁ and sets the second voltage to V_{2B} higher than the default of V₂. As the environmental temperature decreases, the electric power for maintaining and raising the temperature of the heater 121 increases. In this regard, with this configuration, it is possible to easily maintain and raise the temperature of the heater 121 by further increasing the voltage to be applied.

On the other hand, as shown in Table 2, when the environmental temperature is higher than or equal to the second reference value, the controller 116 sets the first voltage and the second voltage to smaller values. The second reference value is larger than or equal to the first reference value. According to the example shown in Table 2, when the environmental temperature is higher than or equal to 30° C., the controller 116 sets the first voltage to VIA lower than the default of V₁ and sets the second voltage to V_{2A} lower than the default of V₂. As the environmental temperature increases, the electric power for maintaining and raising the temperature of the heater 121 decreases. In this regard, with this configuration, it is possible to reduce power consumption while maintaining and raising the temperature of the heater 121 by further decreasing the voltage to be applied.

The controller 116 may determine, based on the environmental temperature, the first voltage and the second voltage before controlling, based on the heating profile, the operation of the heater 121. The environmental temperature may change in accordance with a change in the temperature of the heater 121, for example, the temperature of the space around the inhaler device 100 locally rises as the temperature of the heater 121 rises. In this regard, with this configuration, it is possible to determine the first voltage and the second voltage while eliminating the influence of a change in the temperature of the heater 121.

Although a description has been given of an example in which both the first voltage and the second voltage are controlled based on the environmental temperature, the present invention is not limited to such an example. At least one of the first voltage or the second voltage may be controlled based on the environmental temperature.

### (2) Second Modification

The controller 116 may control, based on the temperature of the heater 121 in the initial temperature rise period, the second voltage. As described above in the first modification, the environmental temperature may affect the temperature of the heater 121. Thus, it is considered that the temperature of the heater 121 in the first period is affected by the environmental temperature. In this regard, with this configuration, it is possible to more appropriately control the temperature of the heater 121 in the temperature re-rise period in consideration of the influence 30 of the environmental temperature determined in the initial temperature rise period.

Specifically, the controller 116 sets the second voltage to a larger value when the temperature rising speed of the heater 121 in the first period is lower than a third reference value. When the temperature rising speed of the heater 121 in the first period is low, the environmental temperature is assumed to be low. In this regard, with this configuration, it is possible to easily maintain and raise the temperature of the heater 121 by further increasing the voltage to be applied.

On the other hand, when the temperature rising speed of the heater 121 in the first period is higher than or equal to a fourth reference value, the controller 116 sets the second voltage to a smaller value. The fourth reference value is larger than or equal to the third reference value. When the temperature rising speed of the heater 121 in the first period is high, the environmental temperature is assumed to be high. In this regard, with this configuration, it is possible to reduce power consumption while maintaining and raising the temperature of the heater 121 by further decreasing the voltage to be applied.

### (3) Third Modification

The controller 116 may control, based on information regarding a puff of an aerosol taken by a user in the initial temperature rise period, the second voltage. Here, an example of the information regarding a puff is the number of puffs. When a puff is taken, outside air flows into the internal space 141, and the temperature of the heater 121 drops. In this regard, with this configuration, it is possible to more appropriately control the temperature of the heater 121 in the temperature re-rise period in consideration of the influence of a puff determined in the initial temperature rise period.

Specifically, the controller 116 sets the second voltage to a larger value when the number of puffs taken in the first period is larger than or equal to a fifth reference value. The temperature of the heater 121 is likely to decrease as the number of puffs increases. Thus, the electric power for maintaining and raising the temperature of the heater 121 is assumed to be large. In this regard, with this configuration, it is possible to easily maintain and raise the temperature of the heater 121 by further increasing the voltage to be applied.

On the other hand, when the number of puffs taken in the first period is smaller than a sixth reference value, the controller 116 sets the second voltage to a smaller value. The sixth reference value is smaller than or equal to the fifth reference value. The temperature of the heater 121 is less likely to decrease as the number of puffs decreases. Thus, the electric power for maintaining and raising the temperature of the heater 121 is assumed to be small. In this regard, with this configuration, it is possible to reduce power consumption while maintaining and raising the temperature of the heater 121 by further decreasing the voltage to be applied.

### (4) Fourth Modification

The controller 116 may control, based on the type of the stick substrate 150 to be heated by the heater 121, at least one of the first voltage or the second voltage. The type and the content of an aerosol source and a flavor source vary in each type of the stick substrate 150, and the ease of temperature rise is considered to vary accordingly. In this regard, with this configuration, it is possible to more appropriately control the temperature of the heater 121 in consideration of the ease of temperature rise for each type of the stick substrate 150.

### (5) Fifth Modification

In the above-described embodiment, an example in which the inhaler device 100 includes one heater 121 has been described, but the present invention is not limited to such an example. The inhaler device 100 may include a plurality of heaters 121. In this case, the controller 116 controls, at a timing corresponding to the heating profile, the voltage to be applied to each of the plurality of heaters 121. The plurality of heaters 121 heat different portions of the stick substrate 150. In this regard, with this configuration, it is possible to control the temperature of each portion of the stick substrate 150 with an appropriate voltage. Accordingly, it is possible to reduce power consumption while delivering a more appropriate flavor to the user.

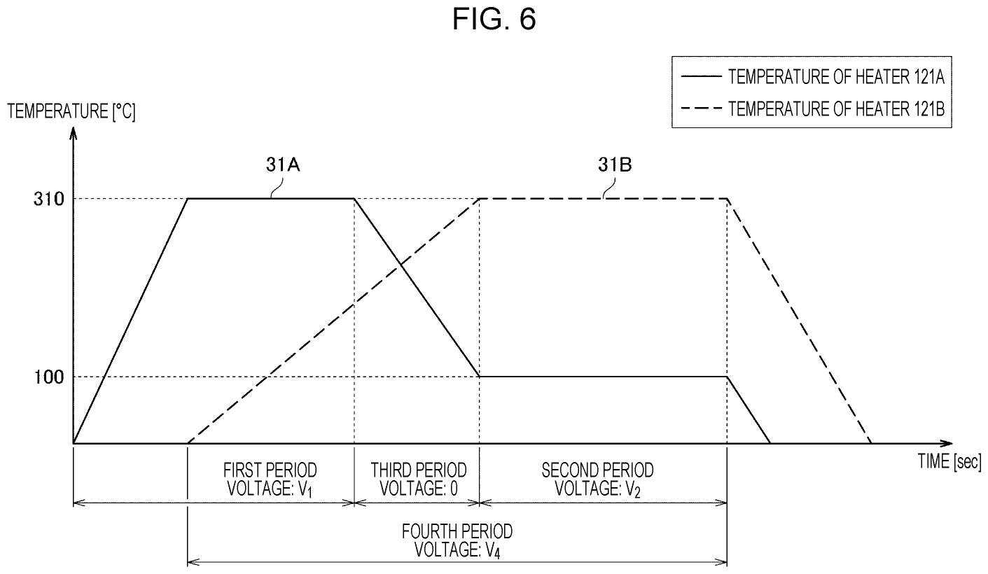

The voltage control performed when the inhaler device 100 includes two heaters 121 will be described with reference to FIG. 5 and FIG. 6.

FIG. 5 is a schematic diagram of a configuration example of the inhaler device 100 according to the present modification. As illustrated in FIG. 5, the inhaler device 100 according to the present modification is different from the example illustrated in FIG. 1 in that the inhaler device 100 includes two heaters 121 (heaters 121A and 121B). Hereinafter, a description will be given mainly of the differences from the configuration described above with reference to FIG. 1 among the configurations of the structural elements of the inhaler device 100 according to the present modification.

The heater 121A and the heater 121B are disposed at different positions in the direction in which the stick substrate 150 is inserted. Specifically, the heater 121A is disposed near the opening 142, that is, disposed on a downstream side. On the other hand, the heater 121B is disposed near the bottom 143, that is, disposed on an upstream side. When a puff is taken, an air flow from the upstream side toward the downstream side is generated.

The controller 116 first raises the temperature of the heater 121A, and then raises the temperature of the heater 121B. In an example, the controller 116 may start heating or raise the temperature to a maximum temperature sequentially from the heater 121A to the heater 121B. With this configuration, the aerosol source is heated sequentially from the downstream side to the upstream side of the substrate 151, and an aerosol is generated. If an upstream-side portion of the substrate 151 is heated before a downstream-side portion, the aerosol generated on the upstream side may be cooled and condensed when passing through the downstream-side portion. In this case, the downstream-side portion of the substrate 151 that has not been heated is moistened, and the flavor that the user tastes when the downstream-side portion of the substrate 151 is heated may be deteriorated. In this regard, with this configuration, a generated aerosol does not pass through an unheated portion of the substrate 151. Accordingly, the unheated portion of the substrate 151 is prevented from getting wet, and it is possible to prevent deterioration of the flavor that the user tastes.

FIG. 6 is a graph showing an example of the transition of the temperature of the heater 121 in the present modification. The vertical axis of this graph represents the temperature of the heater 121. The line 31A in this graph indicates the transition of the temperature of the heater 121A. The line 31B in this graph indicates the transition of the temperature of the heater 121B. As illustrated in FIG. 6, in the initial first period, the temperature of the heater 121A rapidly rises to reach 310° C., and is then maintained at 310° C. The temperature of the heater 121A drops to 100° C. in the third period, and is maintained at 100° C. in the subsequent second period. On the other hand, the temperature of the heater 121B slowly rises to 310° C. in a fourth period that starts after the first period has started, and reaches 310° C. at the timing at which the temperature of the heater 121A has dropped to 100° C. Thereafter, upon the termination of the second period and the fourth period, the temperatures of the heater 121A and the heater 121B drop.

The controller 116 performs control such that the first voltage V₁ is applied to the heater 121A in the first period and that the second voltage V₂ is applied to the heater 121A in the second period. With this configuration, it is possible to rapidly raise the temperature of the heater 121A in the first period and terminate preheating early. Also, it is possible to maintain the temperature of the heater 121A in the second period and prevent the aerosol generated in the upstream-side portion of the substrate 151 from being cooled and condensed when passing through the downstream-side portion.

The controller 116 performs control such that no voltage is applied to the heater 121A in the third period interposed between the first period and the second period. As a result of adjusting the voltage before and after the third period during which no voltage is applied to the heater 121A, it is possible to prevent noise from being superimposed on the gain of PID controller. Thus, it is possible to appropriately control the temperature of the heater 121A throughout the period from the start of the first period to the end of the second period, and deliver an appropriate aerosol to the user.

The first voltage V₁ is higher than the second voltage V₂. With this configuration, it is possible to prevent the depletion of the aerosol source and reduce power consumption in the second period while shortening the preheating period.

On the other hand, in the fourth period that overlaps the first period and the second period, the controller 116 performs control such that a fourth voltage is applied to the heater 121B. More simply, the controller 116 performs control such that the fourth voltage is constantly applied to heater 121B. With this configuration, it is possible to prevent noise from being superimposed on the gain of PID controller. Thus, it is possible to appropriately control the temperature of the heater 121B throughout the fourth period, and deliver an appropriate aerosol to the user.

The fourth voltage is lower than the first voltage and higher than the second voltage. As illustrated in FIG. 6, the temperature of the heater 121A reaches 310° C. before the temperature of the heater 121B reaches 310° C., and a sufficient amount of aerosol is generated on the downstream side. Thus, it is not necessary to rapidly raise the temperature of the heater 121B. In this regard, with this configuration, it is possible to sufficiently raise the temperature of the heater 121B while reducing power consumption.

### 4. Supplementary Description

While a preferred embodiment of the present invention has been described in detail with reference to the accompanying drawings, the present invention is not limited to the foregoing examples. It will be apparent that those skilled in the art to which the present invention belongs are able to conceive of various modifications or variations within the scope of the technical ideas described in the claims, and it is understood that such modifications or variations also belong to the technical scope of the present invention.

A series of processes performed by the individual devices described in this specification may be implemented by using any of software, hardware, and a combination of software and hardware. Programs constituting the software are stored in advance in, for example, a recording medium (specifically, a non-transitory computer-readable storage medium) provided inside or outside each device. Each program is read into a RAM and is executed by a processor such as a CPU when being executed by a computer that controls each device described in this specification, for example. The recording medium is, for example, a magnetic disk, an optical disc, a magneto-optical disc, a flash memory, or the like. In addition, the foregoing computer programs may be distributed via a network, for example, without using a recording medium.

In addition, the process described using a flowchart and a sequence diagram in this specification need not necessarily be executed in the illustrated order. Some processing steps may be executed in parallel. In addition, an additional processing step may be employed, and some processing steps may be omitted.

The following configurations also belong to the technical scope of the present invention.

(1)

An inhaler device including:

a heater configured to heat a substrate including an aerosol source to generate an aerosol; and

a controller configured to control, based on a temperature setting defining a time-series transition of a target temperature, the target temperature being a target value of a temperature of the heater, an operation of the heater, wherein

the controller is configured to perform control such that a first voltage is applied to the heater in a first period among a plurality of periods included in the temperature setting and that a second voltage different from the first voltage is applied to the heater in a second period different from the first period among the plurality of periods.

(2)

The inhaler device according to (1) above, wherein

the temperature setting includes a third period between the first period and the second period, and

the controller is configured to perform control such that no voltage is applied to the heater in the third period.

(3)

The inhaler device according to (2) above, wherein

the third period is a period during which the temperature of the heater drops.

(4)

The inhaler device according to any one of (1) to (3) above, wherein

the first period is a period during which the temperature of the heater rises from a temperature at start of heating to a predetermined temperature.

(5)

The inhaler device according to any one of (1) to (4) above, wherein

the second period is a period after the temperature of the heater has dropped and is a period during which the temperature of the heater is maintained or rises.

(6)

The inhaler device according to any one of (1) to (5) above, wherein

the first voltage is higher than the second voltage.

(7)

The inhaler device according to any one of (1) to (6) above, wherein

the controller is configured to control, based on an environmental temperature, at least one of the first voltage or the second voltage.

(8)

The inhaler device according to (7) above, wherein

the controller is configured to set at least one of the first voltage or the second voltage to a larger value when the environmental temperature is lower than a first reference value.

(9)

The inhaler device according to (7) or (8) above, wherein

the controller is configured to set at least one of the first voltage or the second voltage to a smaller value when the environmental temperature is higher than or equal to a second reference value.

(10)

The inhaler device according to any one of (7) to (9) above, wherein

the controller is configured to determine, based on the environmental temperature, at least one of the first voltage or the second voltage before controlling, based on the temperature setting, the operation of the heater.

(11)

The inhaler device according to any one of (1) to (10) above, wherein

the controller is configured to control, based on the temperature of the heater in the first period, the second voltage.

(12)

The inhaler device according to any one of (1) to (11) above, wherein

the controller is configured to control, based on information regarding a puff of the aerosol taken by a user in the first period, the second voltage.

(13)

The inhaler device according to any one of (1) to (12) above, wherein

the controller is configured to control, based on a type of the substrate to be heated by the heater, at least one of the first voltage or the second voltage.

(14)

The inhaler device according to any one of (1) to (13) above, wherein

the inhaler device includes, as the heater, a first heater disposed on a downstream side and a second heater disposed on an upstream side, and

the controller is configured to perform control such that the first voltage is applied to the first heater in the first period, that the second voltage is applied to the first heater in the second period, and that a fourth voltage is applied to the second heater in a fourth period that overlaps the first period and the second period.

(15)

The inhaler device according to (14) above, wherein

the fourth voltage is lower than the first voltage and higher than the second voltage.

(16)

A substrate that includes an aerosol source and that is to be heated by an inhaler device to generate an aerosol, the inhaler device including:

a heater configured to heat the substrate including the aerosol source to generate the aerosol; and

a controller configured to control, based on a temperature setting defining a time-series transition of a target temperature, the target temperature being a target value of a temperature of the heater, an operation of the heater, wherein

the controller is configured to perform control such that a first voltage is applied to the heater in a first period among a plurality of periods included in the temperature setting and that a second voltage different from the first voltage is applied to the heater in a second period different from the first period among the plurality of periods.

(17)

A control method for controlling an inhaler device including a heater configured to heat a substrate including an aerosol source to generate an aerosol, the control method including:

controlling, based on a temperature setting defining a time-series transition of a target temperature, the target temperature being a target value of a temperature of the heater, an operation of the heater, wherein

the controlling of the operation of the heater includes performing control such that a first voltage is applied to the heater in a first period among a plurality of periods included in the temperature setting and that a second voltage different from the first voltage is applied to the heater in a second period different from the first period among the plurality of periods.

### REFERENCE SIGNS LIST

100 inhaler device
111 power supply
112 sensor
113 notifier
114 memory
115 communicator
116 controller
117 DC/DC converter
118 switching element
121 heater
140 holder
141 internal space
142 opening
143 bottom
144 heat insulator
150 stick substrate
151 substrate
152 inhalation port

1. An inhaler device comprising:
a heater configured to heat a substrate including an aerosol source to generate an aerosol; and
a controller configured to control, based on a temperature setting defining a time-series transition of a target temperature, the target temperature being a target value of a temperature of the heater, an operation of the heater, wherein
the controller is configured to perform control such that a first voltage is applied to the heater in a first period among a plurality of periods included in the temperature setting and that a second voltage different from the first voltage is applied to the heater in a second period different from the first period among the plurality of periods.

2. The inhaler device according to claim 1, wherein
the temperature setting includes a third period between the first period and the second period, and
the controller is configured to perform control such that no voltage is applied to the heater in the third period.

3. The inhaler device according to claim 2, wherein
the third period is a period during which the temperature of the heater drops.

4. The inhaler device according to claim 1, wherein
the first period is a period during which the temperature of the heater rises from a temperature at start of heating to a predetermined temperature.

5. The inhaler device according to claim 1, wherein
the second period is a period after the temperature of the heater has dropped and is a period during which the temperature of the heater is maintained or rises.

6. The inhaler device according to claim 1, wherein
the first voltage is higher than the second voltage.

7. The inhaler device according to claim 1, wherein
the controller is configured to control, based on an environmental temperature, at least one of the first voltage or the second voltage.

8. The inhaler device according to claim 7, wherein
the controller is configured to set at least one of the first voltage or the second voltage to a larger value when the environmental temperature is lower than a first reference value.

9. The inhaler device according to claim 7, wherein
the controller is configured to set at least one of the first voltage or the second voltage to a smaller value when the environmental temperature is higher than or equal to a second reference value.

10. The inhaler device according to claim 7, wherein
the controller is configured to determine, based on the environmental temperature, at least one of the first voltage or the second voltage before controlling, based on the temperature setting, the operation of the heater.

11. The inhaler device according to claim 1, wherein
the controller is configured to control, based on the temperature of the heater in the first period, the second voltage.

12. The inhaler device according to claim 1, wherein
the controller is configured to control, based on information regarding a puff of the aerosol taken by a user in the first period, the second voltage.

13. The inhaler device according to claim 1, wherein
the controller is configured to control, based on a type of the substrate to be heated by the heater, at least one of the first voltage or the second voltage.

14. The inhaler device according to claim 1, wherein
the inhaler device comprises, as the heater, a first heater disposed on a downstream side and a second heater disposed on an upstream side, and
the controller is configured to perform control such that the first voltage is applied to the first heater in the first period, that the second voltage is applied to the first heater in the second period, and that a fourth voltage is applied to the second heater in a fourth period that overlaps the first period and the second period.

15. The inhaler device according to claim 14, wherein
the fourth voltage is lower than the first voltage and higher than the second voltage.

16. A substrate that includes an aerosol source and that is to be heated by an inhaler device to generate an aerosol, the inhaler device comprising:
a heater configured to heat the substrate including the aerosol source to generate the aerosol; and
a controller configured to control, based on a temperature setting defining a time-series transition of a target temperature, the target temperature being a target value of a temperature of the heater, an operation of the heater, wherein
the controller is configured to perform control such that a first voltage is applied to the heater in a first period among a plurality of periods included in the temperature setting and that a second voltage different from the first voltage is applied to the heater in a second period different from the first period among the plurality of periods.

17. A control method for controlling an inhaler device including a heater configured to heat a substrate including an aerosol source to generate an aerosol, the control method comprising:
controlling, based on a temperature setting defining a time-series transition of a target temperature, the target temperature being a target value of a temperature of the heater, an operation of the heater, wherein
the controlling of the operation of the heater includes performing control such that a first voltage is applied to the heater in a first period among a plurality of periods included in the temperature setting and that a second voltage different from the first voltage is applied to the heater in a second period different from the first period among the plurality of periods.
